(19) United States
(12) Patent Application Publication
(10) Pub. No.: US 2025/0047697 A1
(43) Pub. Date: Feb. 6, 2025

(54) ANOMALY DETECTION IN NETWORKED ENTITIES

(71) Applicant: Senseon Tech LTD, London (GB)

(72) Inventor: Neil Caithness, London (GB)

(21) Appl. No.: 18/717,926

(22) PCT Filed: Dec. 7, 2022
(86) PCT No.: PCT/EP2022/084783

§ 371 Date: Jun. 7, 2024

(30) Foreign Application Priority Data
Dec. 8, 2021 (GB) 2117723.3

(51) Int. Cl. H04L 9/40

(52) U.S. Cl. CPC H04L 63/1425

(57) ABSTRACT

In a two-phase anomaly detection applied to observations collected from networked entities, observation anomaly scores are obtained in phase 1. In phase 2, the observation anomaly scores are structured as a data matrix, each row of the data matrix corresponding to a time period and each column corresponding to an entity device of the set of networked entities. At least one time period of the data matrix as anomalous. Causal information about the at least one anomalous time period is extracted based on an angular relationship between a second-pass coordinate vector of the at least one time period and a second-pass coordinate vector of at least one entity of the set of networked entities, the second-pass coordinate vectors determined by applying a second-pass singular value decomposition (SVD) to a residuals matrix computed between the data matrix and an approximation of the data matrix via truncated SVD.

### TECHNICAL FIELD

The present disclosure pertains to anomaly detection, and more particularly to the detection of a networked device(s) or other networked entity exhibiting anomalous behaviour or characteristics amongst a set of networked devices or networked entities.

### BACKGROUND

Anomaly detection is widely used in the field of cybersecurity and elsewhere. According to one definition, an anomaly may be characterized as an observation which deviates so much from other observations as to arouse suspicion that it was generated by a different mechanism (see e.g., Hawkins, D. (1980). Identification of Outliers. Chapman and Hall, London.).

Unsupervised anomaly detection may be applied to unlabelled observations, on the assumption the majority of datapoints are ‘normal’. Such techniques can be used, for example, in a cybersecurity context to detect potentially suspicious incidents or patterns of behaviour and take appropriate action in response.

Patent document WO2021078566 (WO'566) teaches a two-stage “double-decomposition” anomaly detection methodology, referred to herein as “Excession”. Excession comprises a first stage referred to as anomaly detection and a second stage referred to as anomaly reasoning. Each stage uses a singular value decomposition (SVD), referred to as first and second-pass SVDs respectively. The first stage is used to identify one or more anomalous observations in a cybersecurity dataset, and the second stage automates the process of understanding what caused an observation to be anomalous. A dataset is structured as a matrix of datapoints (rows) and features associated with each datapoint (columns). In contrast to merely identifying anomalous datapoints (anomaly detection), anomaly reasoning extracts information about the cause of an anomalous datapoint (anomaly). Such causal information is extracted in terms features; given a set of features of a datapoint identified as anomalous, anomaly reasoning can determine the relative extent to which a particular feature contributed to that datapoint being identified as anomalous. One or more of features of an anomalous datapoint which made the highest relative contribution to it being identified as anomalous are referred to as the “causal feature(s)” of the anomalous datapoint.

### SUMMARY

A multi-phase anomaly detection approach is considered herein. In a first phase (phase 1), time-stamped observations from a set of networked devices or other networked entities are assigned observation anomaly scores. In a second phase (phase 2), the per-observation anomaly scores of phase 1 are ‘re-cast’ based on a set of time bins, to provide an anomaly score per entity per time bin. The reformulated anomaly scores are, in turn, subject to a two-stage analysis, firstly to identify any anomalous time bins, and secondly to identify one or more devices that caused a time bin(s) to be identified as anomalous.

According to a first aspect of the present disclosure, a a computer-implemented method of identifying an anomalous entity in a set of networked entities comprises: receiving a set of observations, the set of observations comprising multiple observations for each networked entity, each observation associated with a time stamp; applying anomaly detection to the set of observations, to compute an observation anomaly score for each observation, the observation anomaly score denoting an extent to which the observation is anomalous relative to all other observations across all of the set of networked entities; structuring the observation anomaly scores as a data matrix, each row of the data matrix corresponding to a time period (or time ‘bin’) and each column corresponding to an entity of the set of networked entities; identifying at least one time period of the data matrix as anomalous; and extracting causal information about the at least one time period identified as anomalous based on an angular relationship between a second-pass coordinate vector of the at least one time period and a second-pass coordinate vector of at least one entity of the set of networked entities, the second-pass coordinate vectors determined by applying a second-pass singular value decomposition (SVD) to a residuals matrix, the residuals matrix computed between the data matrix and an approximation of the data matrix by applying a first-pass truncated SVD to the data matrix.

In phase 2, the entities correspond to features in the Excession sense. Therefore, the angular relationship between the coordinate vector of an anomalous time bin and the coordinate vector of an entity quantifies the extent to which the entity caused the time bin to be identified as anomalous. An anomalous entity may, therefore, be defined as an entity that causes a time period to be anomalous in phase 2 (the entity is said to be a causal feature of the anomalous time bin the terminology of Excession).

The steps of identifying anomalous time bin(s) and extracting the causal information may be referred to as an “Ensemble analysis” herein. The goal of the Ensemble analysis is to identify an individual entity (or entities) and timestamp(s) when incongruent behaviour occurs.

The two-phase analysis (observation anomaly detection in phase 1, and Ensemble processing in phase 2) takes into account correlations between entities, rather than just correlations between observations, and in so doing achieves a substantial reduction in noise (e.g., allowing the identification of individual entities(s) of interest and the timestamp(s) of incongruent behaviour by that/those anomalous entity/entities).

Among other things, the present techniques have applications in an “Internet of things” (IoT) context, allowing an anomalous IoT sensor or other IoT device to be identified based on a potentially large set of observations collected from multiple such IoT devices.

IoT is merely one example application, and the described techniques can be applied to any set of networked devices, based on observations comprising one or more of sensor data, network data, endpoint data etc.

One broad application of the techniques is cyber defence, where an anomalous device behaviour or characteristic can be indicative of an attack or other cybersecurity threat (e.g., involving some form of sensor or device tampering, or an attack on or utilizing an entity or entities more generally).

The techniques can be used in other contexts, for example to identify a faulty or misconfigured device within a system of networked devices in a device/system maintenance use case.

Whilst devices, machines and sensors are considered, the techniques can be applied to any entity, including software entities, e.g., any connected entity in a network deployment (such as processes, applications, services, virtual devices or other software entities for which observations can be collected). All description pertaining to devices applies equally to other forms of connected entity.

The described embodiments use a two-phase Excession analysis, which is to say two double-decompositions, in phase 1 and phase 2 respectively. In the first phase, the observations are structured initially in a first data matrix, and the observation anomaly scores are computed by applying a first Excession double-decomposition to the first data matrix. In that context, the above data matrix is a second data matrix, containing or otherwise derived from the observation anomaly scores of phase 1, and the steps of identifying and extracting are performed in the second phase, in which a second Excession double-decomposition is applied to the second data matrix. The second data matrix is structured by time bin and device, with the time bins as datapoints, and each feature column corresponding to an entity, populated based on that entity's timestamped observation anomaly scores as computed in phase 1.

In the second phase, the networked devices become Excession features, with a datapoint provided by the set of observation anomaly scores across the devices in a given time period. Anomaly detection techniques are used to identify a time period for which the set of anomaly scores across the devices is anomalous relative to all other time periods. Anomaly reasoning processing is, in turn, used to identify which feature(s)—that is, which device(s)/entity (or entities)—caused the time period to be identified as anomalous. In this context, an anomalous entity means an entity that caused a time period(s) to be identified as anomalous.

The term “structuring the observation scores as a data matrix” is meant broadly, and includes, for example, the use of time-averaged anomaly scores in the second phase. For example, a time-averaged anomaly score may be assigned to each device in each time bin for use in phase 2, by averaging the phase 1 observation anomaly scores of all observations pertaining to that device within that time bin (based on their timestamps).

In embodiments, the method may comprise a step of automatically identifying an anomalous device (or other entity) of the set of networked devices (or other entities) based on the causal information about the anomalous time period.

For example, the anomalous device (or other entity) may be identified based on a threshold applied to a similarity value (e.g. cosine similarity) calculated between the second-pass coordinate vector of the anomalous time period and the second-pass coordinate vector of that device.

The time period may be identified as anomalous based on: a row of the residuals matrix corresponding to the time period, or the second-pass coordinate vector for the time period.

The time period may be identified as anomalous based on an anomaly score computed as: a sum of squared components of the corresponding row of the residuals matrix, or a sum of squared components of the second-pass coordinate vector for the time period.

The causal information may be extracted based on (i) the angular relationship and (ii) magnitude information about the second-pass coordinate vector of the device.

In embodiments, second causal information may be extracted in respect of at least one time period identified as anomalous and at least one device identified as causing that time period to be identified as anomalous, with the second causal information indicating one or more observation variables that caused that device to be identified as such.

In another aspect, a computer-implemented method of identifying an anomalous entity in a set of networked entities comprises: receiving a set of observations, the set of observations comprising multiple observations for each networked entity, each observation associated with a time stamp; applying anomaly detection to the set of observations, to compute an observation anomaly score for each observation, the observation anomaly score denoting an extent to which the observation is anomalous relative to all other observations across all of the set of networked entities; structuring the observation anomaly scores as a data matrix, each row of the data matrix corresponding to a time period and each column corresponding to an entity device of the set of networked entities; identifying at least one time period of the data matrix as anomalous; and extracting causal information about the at least one time period identified as anomalous based on an angular relationship between a second-pass coordinate vector of the at least one time period and a second-pass coordinate vector of at least one entity of the set of networked entities, the second-pass coordinate vectors determined by applying a second-pass singular value decomposition (SVD) to a residuals matrix, the residuals matrix computed between the data matrix and an approximation of the data matrix by applying a first-pass truncated SVD to the data matrix.

The method may comprise automatically identifying the at least one entity as anomalous based on the angular relationship between the second-pass coordinate vector of the at least one entity and the second-pass coordinate vector of the at least one time period.

For example, the at least one entity may be identified as anomalous based on a threshold applied to a similarity value calculated between the second-pass coordinate vector of the anomalous time period and the second-pass coordinate vector of that entity.

The above causal information may second causal information, and first causal information may be extracted in respect of the at least one time period identified as anomalous and the at least one entity identified as causing that time period to be identified as anomalous. The first causal information may indicate one or more observation variables that caused that entity to be identified as causing that time period to be identified as anomalous.

The above data matrix may be a second data matrix, and the above residuals matrix may be a second residuals matrix. The first causal information may be extracted based on an angular relationship between a second-pass coordinate vector of each observation variable and a second-pass coordinate vector of an observation collected from the at least one entity, the second-pass coordinate vectors determined by applying a second-pass SVD to a first residuals matrix, the first residuals matrix computed between a first data matrix containing the observations and an approximation of the first data matrix by applying a first-pass truncated SVD to the first data matrix.

The above observation variables correspond to columns of the first data matrix in that case.

The anomaly score may be determined for each observation based on: a row of the first residuals matrix corresponding to the observation, or the second-pass coordinate vector of the observation.

For example, the anomaly score may be determined as: a sum of squared components of the corresponding row of the first residuals matrix, or a sum of squared components of the second-pass coordinate vector of the observation.

The at least one time period may be identified as anomalous based on: a row of the (second) residuals matrix corresponding to the time period, or the second-pass coordinate vector for the at least one time period.

For example, the at least one time period may be identified as anomalous based on an anomaly score computed as: a sum of squared components of the corresponding row of the (second) residuals matrix, or a sum of squared components of the second-pass coordinate vector for the at least one time period.

The (second) causal information may be extracted further based on magnitude information about the second-pass coordinate vector of the at least one entity.

The set of networked entities may be a set of networked devices, such as sensor devices with the observations containing sensor measurements.

With sensor devices, each observation variable may a type of sensor measurement.

Further aspects herein provide a computer system comprising one or more processors configured to implement the method of any above aspect or embodiment thereof, and a computer program configured, upon execution by one or more processors, to cause the one or more processors to implement the same.

Embodiments will now be described by way of example only, with reference to the following schematic figures, in which:

### BRIEF DESCRIPTION OF FIGURES

FIG. 1 shows a flow chart for an anomaly detection stage of a single Excession double decomposition;

FIG. 2A shows a flow chart for an anomaly reasoning stage of a single Excession double decomposition and FIG. 2B shows an example of the steps applied in practice;

FIG. 3 provides a schematic overview two-phase anomaly detection processing; and

FIGS. 4 to 10B show results of experiments conducted to verify the efficacy of two-stage anomaly detection applied to networked entities.

### DETAILED DESCRIPTION

The following examples consider multi-phase anomaly processing, based on two data models (‘data model’ referring to the structuring and/or interpretation of the data). A two-phase unsupervised Excession analysis applied to IoT sensor data. As noted, the description applies equally to other forms of networked device/entity.

An Excession model is a double decomposition of a raw data matrix with appropriate encoding and scaling. The numeric columns may be centred and standardized the numeric columns to have a mean of zero and a standard deviation of one (other encoding and scaling strategies can be used, e.g., if a sensor provides a mix of numeric values and categorical error codes, or if the sensor is providing event count data).

The first decomposition of phase 1 (phase 1-stage 1) provides an accurate low rank approximation of a first data matrix containing collected observations, from which an observation anomaly score may be derived as the residual-sum-of-squares (RSS) of each row of the reconstructed data matrix.

The second decomposition of phase 1 (phase 1-stage 2) is performed on the residuals of the reconstruction error from the first decomposition. This provides a mechanism for anomaly reasoning where a signature of the anomalous behaviour may be inferred.

The model output of phase 1 is a single anomaly score per observation, along with associated explanatory metadata for anomaly reasoning, for each row in the test dataset.

Phase 1 takes into account correlation between features collected by the devices and identifies incongruent observations. It does not take into account correlation between devices.

From the perspective of devices, a single-phase Excession analysis is quite noisy. This is addressed by leveraging device correlations in a second-phase of further Excession analysis (providing a form of ‘Ensemble’ analysis).

As indicated, the goal of Ensemble analysis is to identify individual devices and timestamps when incongruent behaviour occurs.

To this end, the output of the phase 1 Excession analysis is reshaped (re-structured) into a second data matrix with devices as feature columns, whose values are time-binned anomaly scores, and a second Excession double-decomposition is applied to the second data matrix.

Excession models can be built on any form of collected data. Experiments have been conducted using (light, temperature, humidity) sensor data, and the results are detailed below.

The following attack scenarios are considered by way of example:
1. An attacker is modifying the data from a sensor or sensors, possibly through physical presence.
2. An attacker has attempted to disable a sensor(s).
3. An attacker is performing a man-in-the-middle attack, modifying data for sensor(s).
4. An attacker is fuzzing the outputs from the BLE sensors, pushing random data to a data collector.
5. An attacker is attempting to provide false data to a data collector.

Such behaviours, among others, are detectable with reduced noise/error, using the unsupervised anomaly detection methodology taught herein.

### Overview

International Patent Publication Number WO2021078566 (WO'566) referred to above, the entire contents of which is incorporated herein by reference, teaches the Excession double-decomposition used herein. In the present example, two-stage anomaly analysis is applied in multiple phases (with two anomaly detection stages and two anomaly reasoning stages in total). Unless otherwise indicated, or context demands otherwise, terminology used herein has the same meaning as WO'566.

TABLE 1
Summary of multi-phase processing

| | Data Model | | | |
|---|---|---|---|---|
| | Features | Datapoints | Stage 1 | |
| | (columns) | (rows) | (detection) | Stage 2 (reasoning) |
| Phase 1 | Variables | Observations | Computes | |
| (Model 1) | | | observation | |
| | | | anomaly scores. | |
| Phase 2 | Devices | Time bins | Computes time | Identifies anomalous |
| (Model 2) | | | bin anomaly | device(s). |
| | | | scores. | |
| Phase 1 | Variables | Observations | | Returns to phase 1, to |
| (Model 1) | | | | identify anomalous |
| | | | | variable(s). |

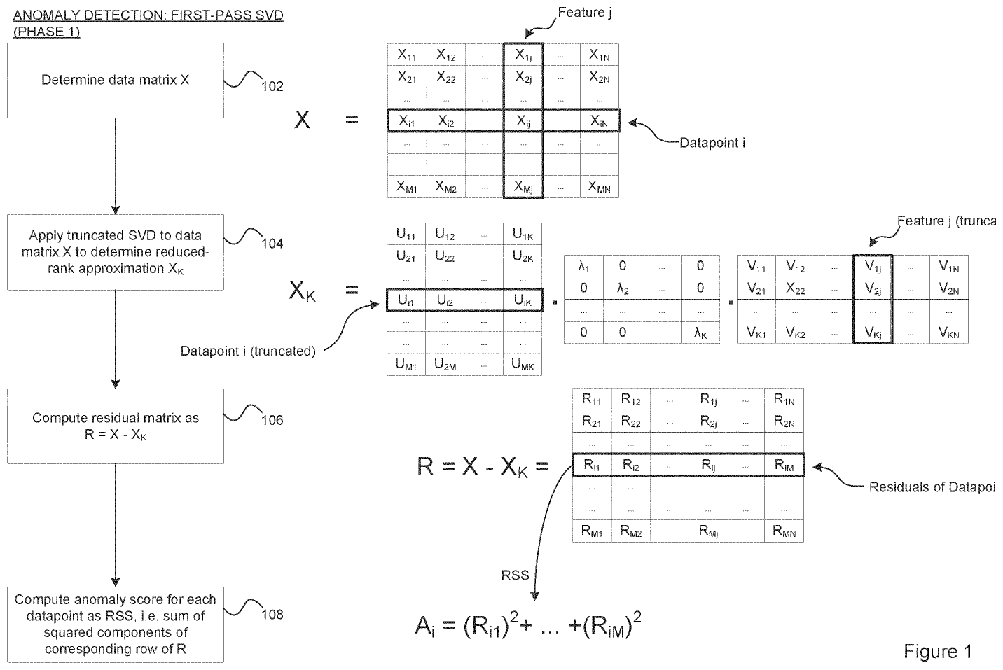

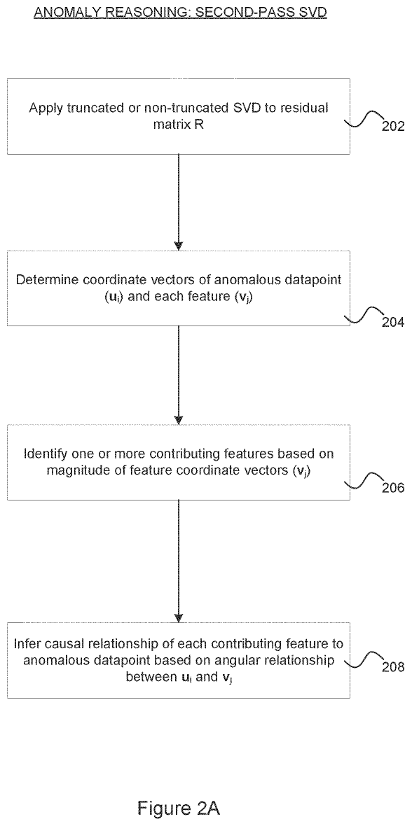

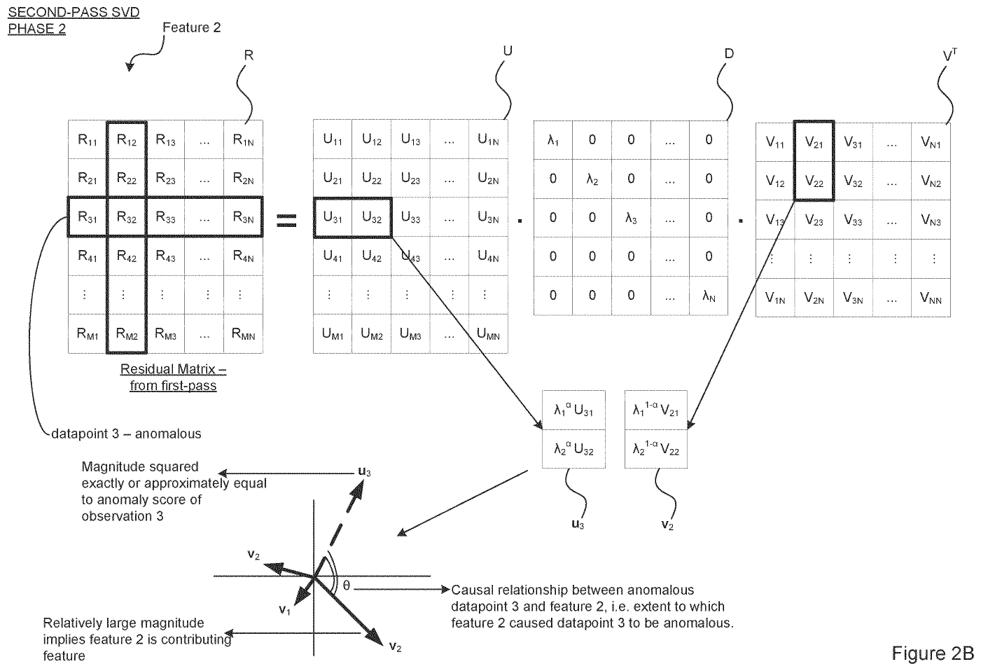

The stage 1 operations are summarized in FIG. 1, whilst the stage 2 operations are summarized in FIGS. 2A and 2B.

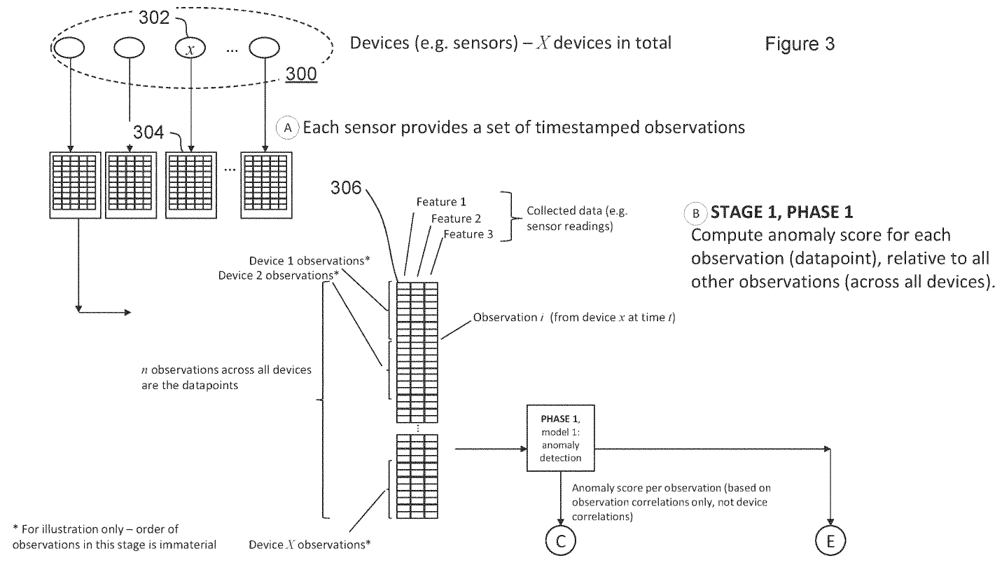

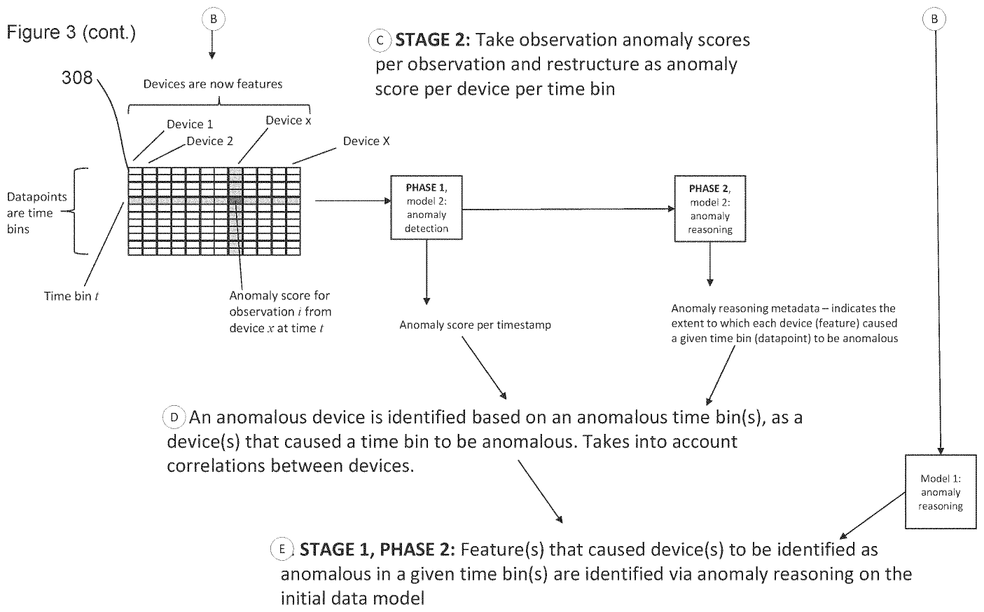

The two-phase processing (incorporating two instances of stage 1 and two instances of stage 2) is summarized in FIG. 3.

FIGS. 1 to 3 are described in further detail below.

The overall processing pipeline is summarised as follows:

Phase 1, stage 1 (anomaly detection on model 1): anomaly scores are computed per-observation.

Phase 2, stage 2 (anomaly detection on model 2): per-observation scores are compiled to provide (e.g., time-averaged) anomaly scores per device per-time bin.

Phase 2, stage 2 (anomaly reasoning on model 2): anomaly reasoning is applied. Given an anomalous time bin(s) identified in stage 1, stage 2 identifies which device(s) caused the given time bin(s) to be identified as anomalous. Hence phase 2, stage 2 identifies device(s) that are anomalous in this sense.

Phase 1, stage 2 (anomaly reasoning on model 1): returns to the data model of phase 1. Given an anomalous time bin(s) and anomalous device(s) in that time bin, processing on the original data model identifies which variable(s) caused that device(s) to be identified as anomalous in that time bin(s). These are the variable(s) that caused the corresponding observation(s) to be identified as anomalous in phase 1, stage 1.

The variables of phase 1 can be any variables of interest. For example, the variables may comprise one or more sensor variables (examples below consider temperature, lighting and humidity readings from IoT sensor devices). Other variables include, for example, network variables, endpoint variables etc. (e.g., of the kind taught in WO′566).

### Anomaly Detection and Reasoning

To provide further context to the described embodiments, further details of two-stage Excession anomaly detection and reasoning approach will now be described.

An SVD can be used to model high dimensional data points with an accurate, low dimensional model. In this case, residuals of this low-rank approximation show the location of model errors. The residual sum of squares (RSS) then shows the accumulation of errors per observation and equates to a measure of anomaly.

In symbolic notation the SVD of an N-by-M matrix X is the factorization X=UDV^{T}. Now consider a K<M low-dimensional approximation X_{K}=U_{K}D_{K}V_{K}^{T}. (The subscripted K notation here indicates using the low dimensional truncated matrixes in constructing the approximation, i.e. just the first K columns of U, D and V.) Residuals of the approximation R=X−Xx show the location of model errors by the magnitude of their departure from zero, and the residual sum of squares (RSS, the row-wise sum of the squared residuals) shows the accumulation of errors per observation. This is the anomaly score Aᵢ.

The factorization UDV^{T} exists and is unique for any rectangular matrix X consisting of real numeric values. If the columns of X have been centred (i.e., have mean of zero achieved by subtracting the column mean from each element of the column) and standardized (i.e., have standard deviation of one achieved by dividing elements of the column by the column standard deviation) then the SVD of X produces an exactly equivalent outcome to the eigen-decomposition of the covariance matrix of X that is usually called a Principal Components Analysis (PCA).

An ‘anomaly’ is distinguished from an outlier in the sense of a statistical edge case. This distinction is important in the context of Excession analysis because the techniques involve a specific mathematical transform that converts anomalies to outliers. The matrix of residuals R provides both a measure of observation anomaly (the RSS scores) in stage 1 and, by performing a second-pass SVD on R, an interpretation of the driving (causal) features of the anomalies in stage 2.

The two-stage methodology is described with reference to FIGS. 1, 2A and 2B.

Both stage 1 and stage 2 are based on respective SVDs. Given a matrix Z, a SVD composition of Z is a matrix factorization which can be expressed mathematically as:

Z=UDV^{T}

in which D is (in general) a rectangular diagonal matrix, i.e., in which all non-diagonal components are non-zero. The diagonal components of D are called “singular values”. In general, D can have non-zero singular values or a mixture of zero and non-zero singular values. The non-zero singular values of D are equal to the square roots of the non-zero eigen values of the matrix ZZ^{T}, and are non-increasing, i.e.

Diag(D)=(D₀,D₁,D₃,D₄, . . . )

where Dₖ₋₁≥Dₖ for all k.

For an M×N matrix Z, U is an M×M matrix, D is an M×N matrix and V is an N×N matrix (the superscript T represents matrix transposition). Note, however, that a “full” SVD is unlikely to be required in practice, because in many practical contexts there will be a significant “null-space” which does not need to decomposed: e.g. for N<M (fewer rows than columns), the final M-N rows will be all zeros—in which case, a more efficient SVD can be performed by computing D as an N×N diagonal matrix, and U as an M×N matrix (so called “thin” SVD). As is known in the art, other forms of reduced SVD may be applied, for example “compact” SVD may be appropriate where D has a number N-r of zero-valued diagonal components (implying a rank r less than n), and U, D and V^{T} are computed as M×r, r×r and r×N matrixes respectively.

There is an important distinction, however, between a “truncated” SVD and a “reduced” SVD. The examples of the preceding paragraph are forms of reduced but non-truncated SVD, i.e., they are exactly equivalent to a full SVD decomposition, i.e., Z is still exactly equal to UDV^{T} notwithstanding the dimensionality reduction.

By contrast a truncated SVD implies a dimensionality reduction such that Z is only approximated as

$$Z \approx {Z}_{K} = {U}_{K} {D}_{K} {V}_{K}^{T} ,$$

in which U_{K}, D_{K} and V_{K}^{T} have dimensions M×K, K×K and K×N respectively. Note, the matrix Z_{K}— the “reduced-rank approximation” of Z—has the same dimensions M×N as the original matrix Z but a lower rank than Z (i.e., fewer linearly-independent columns). Effectively, this approximation is achieved by discarding the r-K smallest singular values of D (r being the rank of D), and truncating the rows and columns of U and V respectively.

In general, notationally, U, D an V indicate a non-truncated (i.e., exact) SVD decomposition (which may or may not be reduced); U_{K}, D_{K} and V_{K} denote a truncated SVD of order K. An appropriate “stopping rule” may be used to determine K. For example, a convenient stopping rule retains only components with eigenvalues greater than 1, i.e., K is chosen such that D_{K}>1 and D_{K+1}≤1.

In the first stage of Excession processing, a first-pass, truncated SVD is applied (FIG. 1, step 104) to a data matrix X, represented in mathematical notation as

$${X}_{K} = {U}_{1 , K} {D}_{1 , K} {V}_{1 , K}^{T} . \qquad ( 1 )$$

In the second phase, a second-pass SVD is applied (FIGS. 2A, step 102) to a residuals matrix R, represented as

$$R = {U}_{2} {D}_{2} {V}_{2}^{T} , \qquad ( 2 )$$

where the residuals matrix is defined as

$$R = X - {X}_{K} ,$$

i.e., as the matrix difference between the data matrix X and its reduced-rank approximation Xx as computed in the first-pass SVD. The above notation assumes the second-pass SVD is non-truncated, however in practice the second-pass SVD may also be truncated for efficiency.

The subscripts 1 and 2 are introduced in Equations (1) and (2) above to explicitly distinguish between the first and second-pass SVDs. Note, however, elsewhere in this description, and in the FIGS., these subscripts are omitted for conciseness, and the notation therefore reverts to U, D, V (non-truncated) and U_{K}, D_{K}, V_{K} (truncated) for both the first and second passes—it will be clear in context whether this notation represents the SVD matrixes of the first pass (as applied to the data matrix X—see Equation (1)) or the SVD matrixes of the second-pass (as applied to the residuals matrix R—see Equation (2)).

Although not explicitly indicated in the notation, it will be appreciated that appropriate normalization may be applied to the data matrix X and the residuals matrix R in the first and second-pass SVD respectively. Different types of normalization can be applied. SVD is a class of decomposition that encompasses various more specific forms of decomposition, including correspondence analysis (CA), principal component analysis (PCA), log-ratio analysis (LRA), and various derived methods of discriminant analysis. What distinguishes the various methods is the form of the normalization applied to Z (e.g., X or R) before performing the SVD.

### Stage 1-Anomaly Detection

FIG. 1 shows, on the left-hand side, a schematic flow chart for an anomaly detection stage (stage 1). The right-hand side schematically illustrates an application of the method steps.

At step 102, a data matrix X is determined. This represents a set of datapoints as rows of the data matrix X, i.e., each row of X constitutes one data point. Each column X represents a particular feature. Hence, an M×N data matrix X encodes M data points as rows, each having N feature values. Component Xᵢⱼ in row i and column j is the value of feature j (feature value) for data point i. Note the terms “row” and “column” are convenient labels that allow the subsequent operations to be described more concisely in terms of matrix operations. Data may be said to be “structured as a M×N data matrix” or similar, but the only implication of this language is that each datapoint of the M datapoints is expressed as respective values of a common set of N features to allow those features to be interpreted in accordance with the anomaly detection/reasoning techniques disclosed herein. That is to say, the terminology does not imply any additional structuring beyond the requirement for the datapoints to be expressed in terms of a common feature set.

The method of FIG. 1 is applied, in phase 1-stage 1, to a first data matrix (FIG. 3, 306), with the observations (rows) as datapoints, with the variables as features (columns). In phase 2-stage 1, the method of FIG. 1 is separately applied to a second data matrix (FIG. 3, 308), with the time bins (rows), with the networked devices as features (columns).

By way of example, column j of the data matrix X is highlighted. This corresponds to a particular feature in the feature set (feature j), and the M values of column j are feature values which characterize each of the M datapoints in relation to feature j. This applies generally to any column/feature.

In the present context, each datapoint (row i) could for example correspond to an observed event (network or endpoint), and its feature values Xᵢ₁, . . . , Xᵢₘ in rows 1 to M) characterise the observed event in relation to features 0 to M. As another example, each datapoint could represent multiple events (network and/or endpoint), and in that case the feature values Xᵢ₁, . . . , Xᵢₘ characterize the set of events as a whole. For example, each datapoint could represent a case relating to a single event or to multiple events, and the feature values Xᵢ₁, . . . , Xᵢₘ could characterise the case in terms of the related event(s).

The term “observation” is also used to refer to a datapoint (noting that, in a cybersecurity application, an observation in this sense of the word could correspond to one or multiple events of the kind described above; elsewhere in this description, the term observation may be used to refer to a single event. The meaning will be clear in context.) At step 104, the first-pass SVD is applied to the data matrix X, as in Equation (1) above, which in turn allows the residuals matrix R=X−X_{K} to be computed at step 106.

At step 108, the residuals matrix R is used to identify any anomalous datapoint in X as follows. An anomaly score Aᵢ is computed for each datapoint i as residual sum of squares (RSS), defined as

$${A}_{i} = {\sum }_{j = 1}^{M} {R}_{ij}^{2} ,$$

i.e. as the sum of the squares of the components of row i of the residuals matrix R (the residuals for datapoint i).

Any datapoint with a threat score Aᵢ that meets a defined anomaly threshold A is classed as anomalous. As will be appreciated, a suitable anomaly threshold A can be set in various ways. For example, the anomaly threshold may be set as a multiple of a computed interquartile range (IQR) of the anomaly scores. For example, a Tukey boxplot with an outlier threshold of 3×IQR may be used, though it will be appreciated that this is merely one illustrative example.

Intuitively, anomalous datapoints are datapoints for which the approximation X_{K} “fails”-leading to a significant discrepancy between the corresponding rows of X and X_{R}, culminating in a relatively high anomaly score.

### Stage 2-Anomaly Reasoning

FIG. 2A shows a schematic flow chart for the steps of an anomaly reasoning stage (stage 2). FIG. 2B provides an illustrative example of how those steps might be applied. For the purpose of the following description, it is assumed that at least one datapoint is identified as anomalous in the first phase of the method, i.e., it is assumed at least one datapoint has an anomaly score Aᵢ which meets the anomaly threshold A.

At step 202, a second-pass SVD is applied to the residuals matrix R as computed in stage 1 at step 106. That is to say, the residuals matrix R of the first-pass is decomposed as set out in Equation (2).

In phase 1-stage 2, the method of FIG. 2 is applied to the observations (rows), based on the residuals of phase 1-stage 1. In phase 2-stage 2, the method of FIG. 2 is separately applied to the residuals of phase 2-stage1.

At step 204, “coordinate vectors” of both the datapoints (observations in phase 1; time bins in phase 2) and the features (variables in phase 1; devices in phase 2) are determined. The coordinate vector of a given datapoint i is denoted by u; (corresponding to row i of X) and the coordinate vector of a given feature j is denoted by vⱼ (corresponding to column j of X). The coordinate vectors are computed as follows (the first line of the following repeats equation (2) for reference):

R=UDV^{T}

Vⱼ=colⱼ[V^{T}]

uᵢ^{T}=rowᵢ[UD]

where “colⱼ [V^{T}]” means column j of the matrix Vⱼ or the first P components thereof, and “rowᵢ[UD]” means row i of the matrix UD (i.e. the matrix U matrix-multiplied with the matrix of singular values D) or the first P components thereof. The integer P is the dimension of the coordinate vector space (i.e. the vector space of uᵢ and vⱼ), which in general is less than or equal to the number of rows in UD (the number of rows in UD being equal to the number of columns in V).

For a “full-rank” coordinate vector space, P is at least as great as the rank of D.

Because of the way in which the SVD is structured—and, in particular, because D is defined as having non-increasing singular values along the diagonal—the greatest amount of information is contained in the first component (i.e. in the left-most components of U, and the top-most components of V^{T}). Hence, it may be viable in some contexts to discard a number of the later components for the purpose of analysis.

The coordinate vector u; may be referred to as the “observation coordinate vector” of datapoint (observation) j; the coordinate vector vⱼ may be referred to as the “feature coordinate vector” of feature j.

The above is a special case of a more general definition of the coordinate vectors. More generally, the coordinate vectors may be defined as:

$${ν}_{j} = {col}_{i} [ {( {VD}^{1 - α} )}^{T} ]$$

$${u}_{i}^{T} = {row}_{i} [ {UD}^{α} ]$$

where the above is the special case of a=1. As with D, D^{a} and D^{1-a} each has no non-zero off diagonal components, and their diagonal components are:

$$diag {D}^{α} : = ( {D}_{0}^{α} , … {D}_{N}^{α} ) ,$$

$$diag {D}^{1 - α} : = ( {D}_{0}^{1 - α} , … {D}_{N}^{1 - α} ) .$$

The case of a=1 is assumed throughout this description. However, the description applies equally to coordinate vectors defined using other values of a. For example, a=0 and a=0.5 may also be used to define the coordinate vectors.

At step 206, one or more “contributing” features are identified. A contributing feature means a feature that has made a significant causal contribution to the identification of the anomalous datapoint(s) in the first phase. Assuming multiple anomalous datapoints have been identified, the aim at this juncture is not to tie specific anomalous datapoints to particular features, but rather to identify features which contribute to the identification of anomalies as a whole.

A feature j is identified as a contributing feature in the above sense based on the magnitude of its feature coordinate vector vⱼ. The magnitude of the feature coordinate vector, |vⱼ|, gives a relative importance of that feature j in relation to the detected anomalies.

For example, it may be that only feature(s) with relative coordinate vector magnitude(s) above a defined threshold are classed as causally relevant to the detected anomaly/anomalies. Alternatively, it may be that only a defined number of features as classed as causally relevant, i.e. the features with the highest magnitude feature coordinate vectors.

For a non-truncated (exact) second-pass SVD of the residuals R, the magnitude squared of the observation coordinate vector |uᵢ|² is exactly equivalent to the threat score Aᵢ, i.e.

$${A}_{i} = {\vert {u}_{i} \vert}^{2} .$$

For a truncated second-pass SVD, this relationship holds approximately, i.e.

$${A}_{i} \approx {\vert {u}_{i} \vert}^{2} .$$

Hence, the anomaly scores used at step 108 may be computed exactly or approximately as

(UD)²

where Aᵢ is computed exactly or approximately as component i of the vector (UD)²=(|u₁|², |u₂|², |u₃|² . . . ).

More generally, the anomaly score Aᵢ can be any function of the components of row i or R or any function of row i of UD that conveys similarly meaningful information as the RSS.

Contributing feature(s) in the above sense may be referred to as the anomaly detection “drivers”.

Having identified the anomaly detection drivers, at step 108, a causal relationship between each anomalous datapoint i and each contributing feature j is identified, based on an angular relationship between the coordinate vector of that datapoint uᵢ and the coordinate vector of that feature vⱼ. Specifically, a Pearson correlation between that datapoint and that feature is determined as the cosine similarity of those vectors (the latter being provably equivalent to the former), i.e. as

$$cos θ = \frac{{u}_{i} \cdot {v}_{j}}{\vert {u}_{i} \vert \vert {v}_{j} \vert} .$$

For a full-rank coordinate vector space, the cosine is exactly equal to the Pearson correlation coefficient; for a reduced-rank coordinate vector space (P less than the rank of D), this relationship is approximate.

A small cosine similarity close to zero (θ close to 90 or 270 degrees) implies minimal correlation—i.e., although feature j might be a driver of anomalies generally, it has not been a significant causal factor in that particular datapoint j being anomalous, i.e. it is not a causal feature of anomalous datapoint i specifically.

By contrast, a cosine similarity close to one (θ close to 0 or 180 degrees) implies a high level of correlation—i.e. feature j has made a significant contribution to datapoint i being identified as anomalous, i.e. it is a causal feature of anomalous datapoint i specifically. A negative (resp. positive) cosine indicates the feature in question is significantly smaller (resp. larger) than expected, and that is a significant cause of the anomaly.

Two-phase approach to anomalous device detection

The two-phase detection approach will now be described in further detail. The application of the method to IoT sensors is described. However, as noted, the description applies equally to other forms of networked device or entity.

FIG. 3 shows a schematic diagram of the steps involved in the two-phase processing.

At step A, a dataset is collected from a set of multiple IoT devices 300. A set of time-stamped observations 304 is obtained from each IoT device 302 (x).

The observations are collated in a first data matrix 306, where each row contains an observation, and each column corresponds to a feature. Each feature is described as a variable in phase 1, where each variable is, in this example, a particular type of sensor measurement (e.g., temperature, light level, humidity etc.), and each observation is a set of corresponding numerical measurements taken by a particular IoT device at a particular time. Hence, in this example, each datapoint i (contained in the ith row of the first data matrix 306) is a set of measurements from some device x at some time t (observation i in this example).

In other use cases, any variables of interest can be used, to which different values may be assigned at different times in respect of the same device/entity. In this case, each observation is a set of values associated with some device/entity at some time.

FIG. 3 considers n observations in total across all IoT devices, with typically multiple observations from each device with different timestamps.

The time stamps are not used in Step A, and the devices are not identified in the first data matrix 306. Step A is therefore independent of where and when the observations have come from. The associations between each IoT device and the corresponding observations are maintained to allow anomalous device(s) to be subsequently identified. However, at this point in the process, the aim is simply to identify any anomalous set(s) of measurements (observations), out of all observations across all devices. The ordering of the observations in the first data matrix 306 is immaterial.

Phase 1-stage 1: Hence, at step B (phase 1-stage 1), stage 1 processing (FIG. 1) is applied to the first data matrix 306, containing only the variables but not the time stamps of any device identifiers. This means a first-pass SVD applied to the first data matrix 306, and the result is an anomaly score for each set of measurements (based on observations correlations only; not device correlations at this phase).

The observation anomaly score assigned to observation i is denoted Aᵢ.

The observation anomaly scores of step B are used subsequently in both steps C and E, a described below.

At step C, the observation anomaly scores are restructured into a second data matrix 308. In the second data matrix 308, denoted S=(S_{x,t}), each row t is now a time bin, and each column x corresponds to an IoT device. Component (t, x) of the second data matrix 308 (row t, collum x) contains an anomaly score for device x in time bin t, denoted S_{t,x} (device-time score). This assumes at least one observation was received from device x in time period t. If only a single observation i was received from device x in that time period t, the device-time score is equal to the anomaly score assigned to that observation in step B, i.e., S_{t,x}=Aᵢ. The time periods may be chosen so that a single observation is typically received from each device in respect of each time period.

Alternatively, the duration of each time bin may be chosen so that multiple observations are typically received from each device in respect of each time bin. In this case, the device-time score S_{t,x} may be computed as an average (e.g., mean) of the anomaly scores received from device x in respect of that time period t.

Step C involves both stage 1 (FIG. 1) and stage 2 (FIGS. 2A-2B) processing:

Phase 2-stage 1: an anomaly score is assigned to each time bin t, by applying stage 1 processing to the second data matrix 308. This means computing the residuals matrix of the second data matrix 308, based on a truncated first-pass SVD of the second data matrix 308. The result is an anomaly score for each time bin (derived from the device anomaly scores contained in the second data matrix 308).

Phase 2-stage 2: anomaly reasoning is applied to the results of phase 2-stage 1. This means a second-pass SVD of the residuals matrix of the second data matrix 308, S. The result is anomaly reasoning metadata of the kind described above. Recall that, in the second data matrix 308, each ‘observation’ is now a time bin, and each ‘feature’ is now an IoT device.

Thus, in applying the stage 1 and stage 2 processing, a coordinate vector wₜ (obtained in the same way as uᵢ above but from the second data matrix 308 S) is obtained for each time bin t (row), and a coordinate vector yₓ (obtained in the same way as vₓ but form the second data matrix 308 S) is obtained for each device x (column). According to the principles described above, the cosine similarity between wₜ and yₓ, therefore, quantifies the extent to which device x caused time bin t to be identified as anomalous (that is, device x's relative contribution to time bin t's anomaly score).

Accordingly, at step D, any anomalous device(s) may as a device(s) that caused a time bin to be anomalous. This approach accounts for correlations between devices.

Phase 1-stage 2: Finally, at step E, assuming at least one device is identified as anomalous in step D, individual variable(s) that caused that device to be anomalous can be identified, based on a second-pass SVD on the residuals matrix of the first data matrix 306. The device anomaly scores of phase 2 are ultimately derived from the observation anomaly scores of phase 1. Hence, once a device 302 has been identified as anomalous in phase 2, anomaly reasoning applied to the observation anomaly scores of the subset of observations 304 collected from that device in stage 1 allows causal feature(s) to be determined in respect of the anomalous device 302.

A naïve alternative would be to identify an anomalous device directly based on its observation anomaly scores as calculated in phase 1, without applying the phase 2 processing. However, as noted, that would not adequately account for correlations between devices, and would therefore suffer from a significantly higher level of noise, e.g., resulting in a significant number of false detections (in this context arises when a legitimate device is incorrectly classed as anomalous) and/or missed detections (when a genuinely suspicious behaviour is missed).

### Experiments

The noise reduction capabilities of the two-stage approach described herein have been demonstrated in experiments conducted using three sensor numeric variables (light, temperature and humidity) for 62 sensors as input to the model. For the phase 1 Excession analysis, analysis we used an nx3 data matrix, containing the light, temperature and humidity values (where n is the number of collected observations). In the second-phase Ensemble analysis we used an mx62 data matrix where n>>m. This Ensemble dataset was then passed to Excession for a second-phase analysis. The results of those experiments are summarized below.

In the example of FIG. 3, phase 1 is ‘device agnostic’ in that it does not distinguish between observations from the same device and observations from different devices. This assumes devices that are ‘homogenous’ with a common set of features (referred to as variables in phase 1) across all devices.

However, device agnosticism is not required in general. The devices need not be homogenous, and variables need not be common across all devices. Instead, the set of observations may be divided into observation subsets, each subset having a common set of variables (different from other subset(s)), and anomaly scores may be computed for each observation subset independently.

Phase 2 proceeds in the same way, aggregating observation anomaly scores across all observation subset(s). Phase 2 only requires the scores, and it is not material in phase 2 whether these have been derived based on a single variable set or multiple variable sets. The only requirement is that the anomaly scores are reasonably comparable between observations (normalisation/scaling may be applied to the observation anomaly scores to the extent needed).

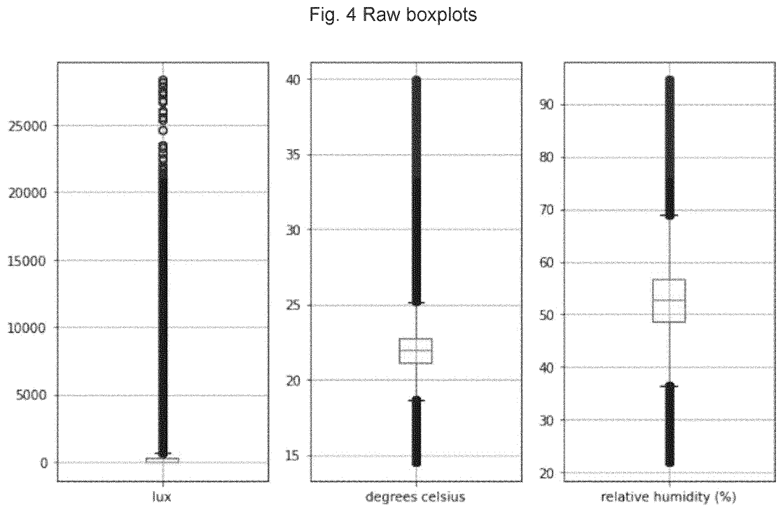

FIG. 4 shows raw box plots of light (lux), temperature (degrees Celsius) and relative humidity (%) data collected from a population of IoT sensors. The majority of the readings are in darkness. Data was obtained from 75 devices over a 24-hour period. Initial pre-processing was applied to the data to assess its quality, resulting in the data from 13 IoT devices being discarded (leaving 62 devices subject to the analysis). See Annex A for further details.

The following observations are made. Values >25,000 are full sunshine. Temperature median values are comfortable indoor temperatures, 22° C. Max values not quite sauna temperature, more like a Turkish Bath or a hot greenhouse, 40° C. Min values not cold, even for summer night-time, i.e. probably not outdoor temperatures, 15° C. Humidity median values are ordinary; max values are greenhouse level. Overall, there are no surprises in the raw data.

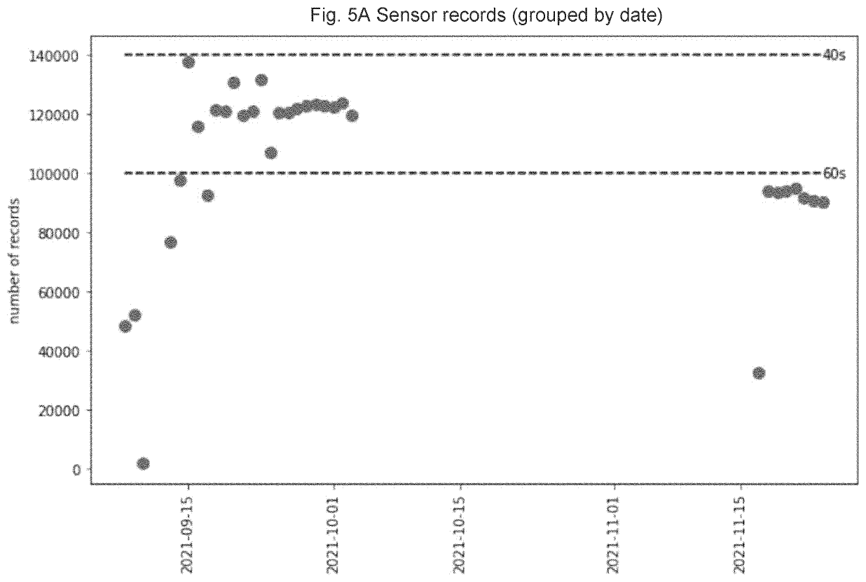

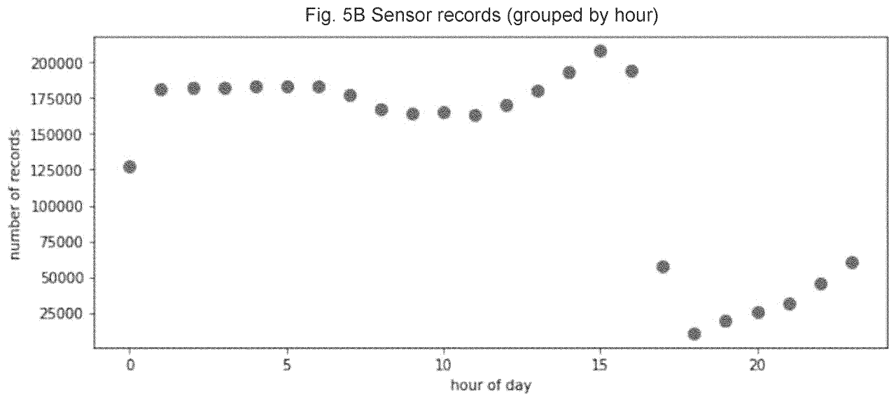

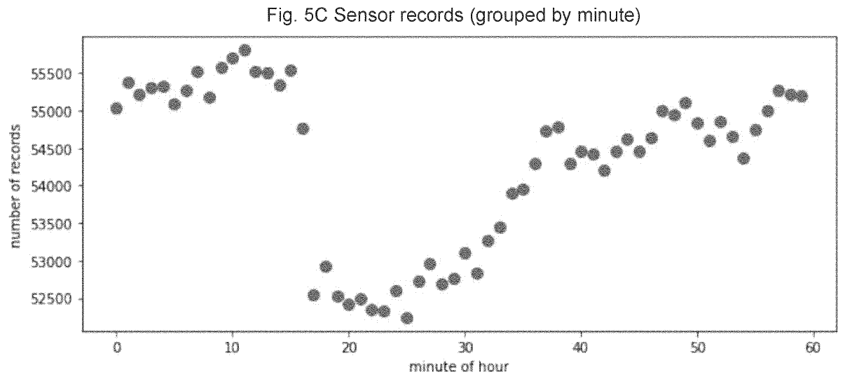

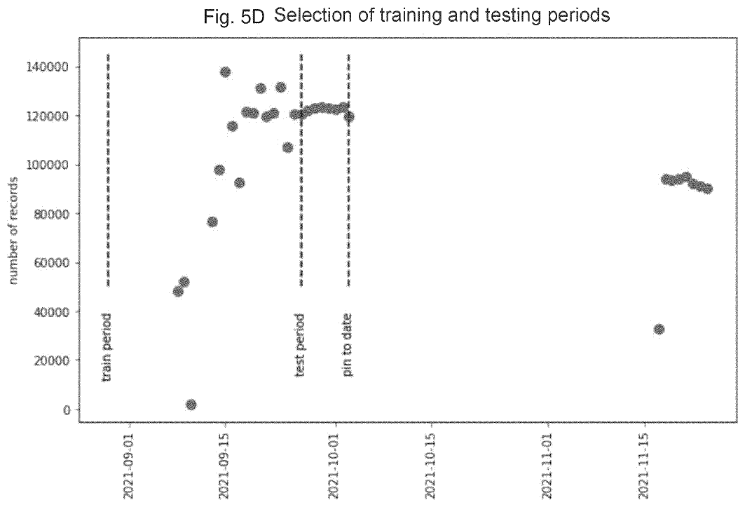

FIGS. 5A-C shows sensor coverage by timestamp. Sensor records grouped by date (FIG. 5A), hour (FIG. 5B) and hour (FIG. 5C).

We built an ensemble execution of Excession for the IoT devices.

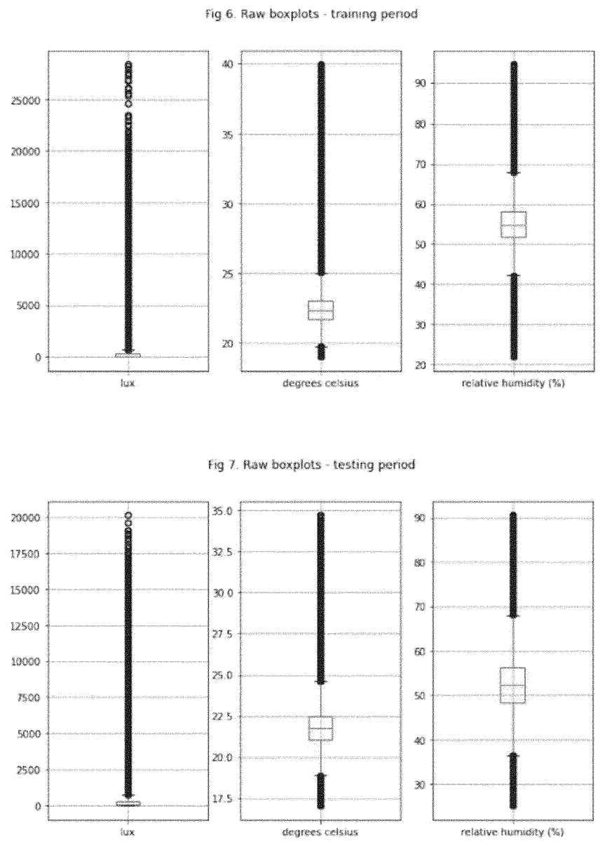

FIG. 6 shows how training and testing period were selected. FIGS. 6 and 7 show raw box plots of the sensor data collected in those periods respectively. The test period was 7 days in length.

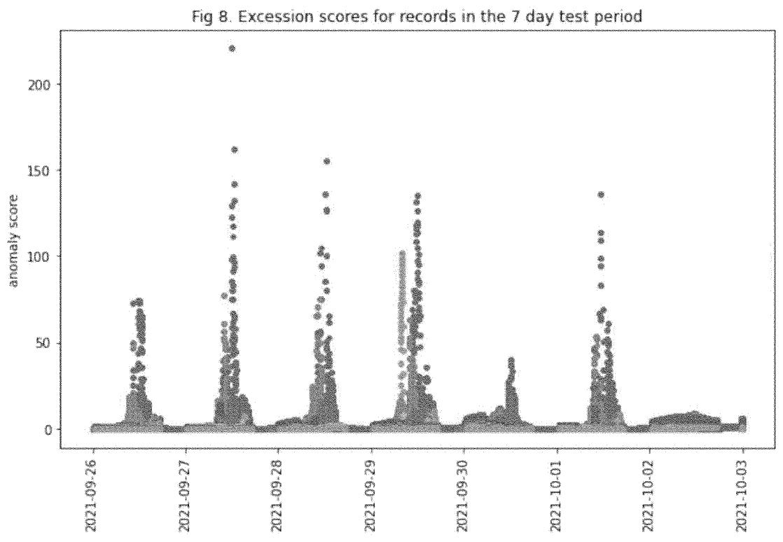

FIG. 8 shows Excession observation anomaly scores calculated in phase 1 over the 7 day test period.

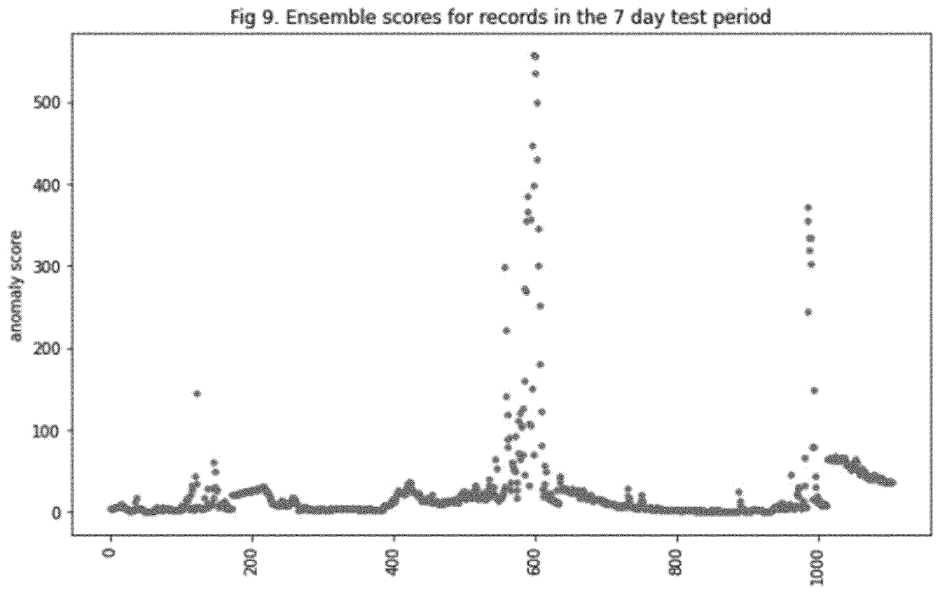

FIG. 9 shows Ensemble scores computed for the records in the 7 day test period (phase 2-stage 1). The Ensemble results allow anomalous time periods to be identified. Note the peaks around 150, 600 and 1000.

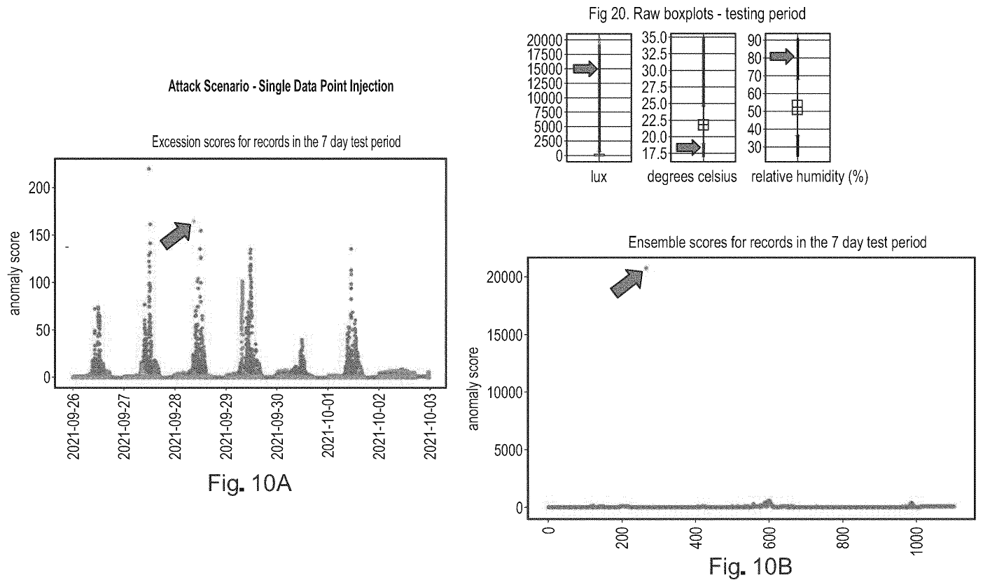

By way of further illustration, FIG. 10A considered attack attach scenario with a single anomalous data point injection. As can be seen, this is successfully identified in the two-phase analysis, depicted in FIG. 10B.

Reference is made in the above to a computer and a computer system comprising one or more such computers configured to implement the described two-phase anomaly detection analysis. A computer comprises one or more computer processors which may take the form of programmable hardware, such as a general-purpose processor (e.g. CPU, accelerator such as a GPU etc.) or a field programmable gate array (FPGA), or any other form of programmable computer processor. A computer program for programming a computer can thus take the form of executable instructions for execution on a general-purpose processor, circuit description code for programming an FPGA etc. Such program instructions, whatever form they take, may be stored on transitory or non-transitory media, with examples of non-transitory storage media including optical, magnetic and solid-state storage. A general-purpose processor may be coupled to a memory and be configured to execute instructions stored in the memory. The term computer processor also encompasses non-programmable hardware, such as an application specific integrated circuit (ASIC).

It will be appreciated that, whilst the specific embodiments of the invention have been described, variants of the described embodiments will be apparent to the skilled person. The scope of the invention is not defined by the described embodiments but only by the appendant claims.

### Annex A—Experimental Data Collection

6 Get Initial Data from BT Data Hub
100% ||76/76 [00:00:00:00, 20.001/a]
Processed 76 files (good—82, bad—13)
Returning DataFrame [3,268,367 rows×5 columns]

### 6.1 Bad Files

Downloaded data for 75 devices (˜24 hours download time).
Bad files are excluded as having either badly-formed benders, or substantial miming data.

### 6.2 Snapshot of Data Frame

Data columns (total 5 columns):

| # | Column | Dtype |
|---|---|---|
| 0 | datetime | datetime64 [ns] |
| 1 | lux | float64 |
| 2 | degrees celsius | float64 |
| 3 | relative humidity (%) | float64 |
| 4 | filename | object |

memory usage: 169.2+MB

### 6.3 Timestamps

Min Date: 2021 Sep. 8 10:10:13
Max Date: 2021 Nov. 24 17:16:42
Date Range: 77 days 07:06:29

1. A computer-implemented method of identifying an anomalous entity in a set of networked entities, the method comprising:
receiving a set of observations, the set of observations comprising multiple observations for each networked entity, each observation associated with a time stamp;
applying anomaly detection to the set of observations, to compute an observation anomaly score for each observation, the observation anomaly score denoting an extent to which the observation is anomalous relative to all other observations across all of the set of networked entities;
structuring the observation anomaly scores as a data matrix, each row of the data matrix corresponding to a time period and each column corresponding to an entity of the set of networked entities;
identifying at least one time period of the data matrix as anomalous; and
extracting causal information about the at least one time period identified as anomalous based on an angular relationship between a second-pass coordinate vector of the at least one time period and a second-pass coordinate vector of at least one entity of the set of networked entities, the second-pass coordinate vectors determined by applying a second-pass singular value decomposition (SVD) to a residuals matrix, the residuals matrix computed between the data matrix and an approximation of the data matrix by applying a first-pass truncated SVD to the data matrix.

2. The method of claim 1, comprising automatically identifying the at least one entity as anomalous based on the angular relationship between the second-pass coordinate vector of the at least one entity and the second-pass coordinate vector of the at least one time period.

3. The method of claim 2, wherein the at least one entity is identified as anomalous based on a threshold applied to a similarity value calculated between the second-pass coordinate vector of the anomalous time period and the second-pass coordinate vector of that entity.

4. The method of claim 2, wherein said causal information is second causal information, and first causal information is extracted in respect of the at least one time period identified as anomalous and the at least one entity identified as causing that time period to be identified as anomalous, wherein the first causal information indicates one or more observation variables that caused that entity to be identified as causing that time period to be identified as anomalous.

5. The method of claim 4, wherein said data matrix is a second data matrix, and said residuals matrix is a second residuals matrix, wherein the first causal information is extracted based on an angular relationship between a second-pass coordinate vector of each observation variable and a second-pass coordinate vector of an observation collected from the at least one entity, the second-pass coordinate vectors determined by applying a second-pass SVD to a first residuals matrix, the first residuals matrix computed between a first data matrix containing the observations and an approximation of the first data matrix by applying a first-pass truncated SVD to the first data matrix.

6. The method of claim 5, wherein the anomaly score is determined for each observation based on:
a row of the first residuals matrix corresponding to the observation, or the second-pass coordinate vector of the observation.

7. The method of claim 6, wherein anomaly score is determined as:
a sum of squared components of the corresponding row of the first residuals matrix, or
a sum of squared components of the second-pass coordinate vector of the observation.

8. The method of claim 5, wherein the at least one time period is identified as anomalous based on:
a row of the second residuals matrix corresponding to the time period, or
the second-pass coordinate vector for the at least one time period.

9. The method of claim 8, wherein the at least one time period is identified as anomalous based on an anomaly score computed as:
a sum of squared components of the corresponding row of the second residuals matrix, or
a sum of squared components of the second-pass coordinate vector for the at least one time period.

10. The method of claim 4, wherein the second causal information is extracted further based on magnitude information about the second-pass coordinate vector of the at least one entity.

11. The method of claim 1, wherein the set of networked entities is a set of networked devices.

12. The method of claim 11, wherein the set of networked devices is a set of networked sensor devices, wherein each observation comprises one or more sensor measurements.

13. The method of claim 12,
wherein said data matrix is a second data matrix, and said residuals matrix is a second residuals matrix, wherein the first causal information is extracted based on an angular relationship between a second-pass coordinate vector of each observation variable and a second-pass coordinate vector of an observation collected from the at least one entity, the second-pass coordinate vectors determined by applying a second-pass SVD to a first residuals matrix, the first residuals matrix computed between a first data matrix containing the observations and an approximation of the first data matrix by applying a first-pass truncated SVD to the first data matrix, and wherein each observation variable is a type of sensor measurement.

14. A computer system for identifying an anomalous entity in a set of networked entities, the computer system comprising:
one or more processors; and
memory coupled to the one or more processors, the memory embodying computer-readable instructions, which, when executed on the one or more processors, cause the one or more processors to:
receive a set of observations, the set of observations comprising multiple observations for each networked entity, each observation associated with a time stamp;
apply anomaly detection to the set of observations, to compute an observation anomaly score for each observation, the observation anomaly score denoting an extent to which the observation is anomalous relative to all other observations across all of the set of networked entities;
structure the observation anomaly scores as a data matrix, each row of the data matrix corresponding to a time period and each column corresponding to an entity of the set of networked entities;
identify at least one time period of the data matrix as anomalous; and
extract causal information about the at least one time period identified as anomalous based on an angular relationship between a second-pass coordinate vector of the at least one time period and a second-pass coordinate vector of at least one entity of the set of networked entities, the second-pass coordinate vectors determined by applying a second-pass singular value decomposition (SVD) to a residuals matrix, the residuals matrix computed between the data matrix and an approximation of the data matrix by applying a first-pass truncated SVD to the data matrix.

15. (canceled)

16. The computer system of claim 14, wherein the computer-readable instructions cause the one or more processors to automatically identify the at least one entity as anomalous based on the angular relationship between the second-pass coordinate vector of the at least one entity and the second-pass coordinate vector of the at least one time period.

17. The computer system of claim 16, wherein the at least one entity is identified as anomalous based on a threshold applied to a similarity value calculated between the second-pass coordinate vector of the anomalous time period and the second-pass coordinate vector of that entity.

18. The computer system of claim 16, wherein said causal information is second causal information, and first causal information is extracted in respect of the at least one time period identified as anomalous and the at least one entity identified as causing that time period to be identified as anomalous, wherein the first causal information indicates one or more observation variables that caused that entity to be identified as causing that time period to be identified as anomalous.

19. The computer system of claim 18, wherein said data matrix is a second data matrix, and said residuals matrix is a second residuals matrix, wherein the first causal information is extracted based on an angular relationship between a second-pass coordinate vector of each observation variable and a second-pass coordinate vector of an observation collected from the at least one entity, the second-pass coordinate vectors determined by applying a second-pass SVD to a first residuals matrix, the first residuals matrix computed between a first data matrix containing the observations and an approximation of the first data matrix by applying a first-pass truncated SVD to the first data matrix.

20. The computer system of claim 19, wherein the anomaly score is determined for each observation based on:
a row of the first residuals matrix corresponding to the observation, or the second-pass coordinate vector of the observation.

21. One or more non-transitory computer readable medium embodying computer program instructions, the computer program instructions configured so as, when executed on one or more hardware processors, to implement operations comprising:
receiving a set of observations, the set of observations comprising multiple observations for each networked entity, each observation associated with a time stamp;
applying anomaly detection to the set of observations, to compute an observation anomaly score for each observation, the observation anomaly score denoting an extent to which the observation is anomalous relative to all other observations across all of the set of networked entities;
structuring the observation anomaly scores as a data matrix, each row of the data matrix corresponding to a time period and each column corresponding to an entity of the set of networked entities;
identifying at least one time period of the data matrix as anomalous; and
extracting causal information about the at least one time period identified as anomalous based on an angular relationship between a second-pass coordinate vector of the at least one time period and a second-pass coordinate vector of at least one entity of the set of networked entities, the second-pass coordinate vectors determined by applying a second-pass singular value decomposition (SVD) to a residuals matrix, the residuals matrix computed between the data matrix and an approximation of the data matrix by applying a first-pass truncated SVD to the data matrix.
